(19) United States
(12) Patent Application Publication
(10) Pub. No.: US 2005/0266827 A1
(43) Pub. Date: Dec. 1, 2005

(54) Method of establishing radio communication networks and radio communication system

(76) Inventor: Myun-Sik Kim, Kyungki-do (KR)

Correspondence Address: Roland R Santucci;Frommer Lawrence & Haug, 745 Fifth Avenue, New York, NY, 10151, US

(21) Appl. No.: 10/497,845

(22) PCT Filed: Dec. 10, 2002
(86) PCT No.: PCT/KR02/02327

§ 371 Date: Jun. 7, 2004

(30) Foreign Application Priority Data
Dec. 10, 2001 (KR) 2001/77790

(51) Int. Cl. H04M 1/68

(52) U.S. Cl. 455/411

(57) ABSTRACT

A method of establishing a wireless communication network constituted by moving communication terminals and a wireless communication system are provided. The wireless communication system includes a manager terminal receiving a password from a user, authorizing the received password, and setting a central or local server point, and a plurality of communication terminals receiving the central or local server point from the manager terminal and storing the received central or local server point. Accordingly, it is possible to provide, without establishing a physically fixed relay base station or an access point, the same effect as that of establishing a relay station for a moving communication terminal.

### TECHNICAL FIELD

The present invention relates to a method of establishing a wireless communication network and a wireless communication system, and more particularly, to a method of establishing a wireless communication network and a wireless communication system comprised of a plurality of base stations, which enable wireless communications between the base stations and communication terminals.

### BACKGROUND ART

In conventional communications techniques, a middle server (base station) or a central server (base station) serving as a relay station needs to be established in a predetermined region in order to manage communication terminals in the predetermined region over a wireless communication network or connect the communication terminals to the Internet via remote control or to enable any of the communication terminals to communicate with another communication terminal in a remote area. However, according to such conventional communications techniques, once a relay base station serving a predetermined region breaks down, the communication terminals in the predetermined region become unable to communicate with one another. In the meantime, there is an ad-hoc method for communications between communication terminals. However, the ad-hoc method also has a problem in that it is difficult to figure out the locations of moving communication terminals.

### DISCLOSURE OF THE INVENTION

The present invention provides a method of establishing a wireless communication network where a predetermined area represented by predetermined longitudinal and latitudinal coordinate values is set as a server point and a communication terminal closest to the server point is set as a central or local server terminal.

The present invention also provides a method of establishing a relay server during the establishment of the wireless communication network.

The present invention also provides a method of replacing a relay server with another relay server during the establishment of the wireless communication network.

The present invention also provides a wireless communication method over a wireless communication network established by the method of establishing a wireless communication network.

The present invention also provides a wireless communication system established by the method of establishing a wireless communication network.

The present invention also provides a wireless communication terminal used in the wireless communication network.

According to an aspect of the present invention, there is provided a method of establishing a wireless communication network. The method involves (a) determining a manager terminal, which selects central and local servers from among a plurality of communication terminals and receives and manages location information of each of the communication terminals, (b) setting a central or local server point using the manager terminal, and (c) determining a communication terminal closest to the central or local server point as a central or local server.

Preferably, step (a) includes (a1) authorizing a first password input from a user, (a2) checking whether or not there exists a second communication terminal, which has already been set as a manager terminal, among communication terminals belonging to the same communication group as a first communication terminal which is determined as the manager terminal, if the first password is correct, (a3) receiving a second password from the user and authorizing the second password if there exists the second communication terminal, and (a4) transmitting a command to cancel setting of the second communication terminal as a manager terminal to the second communication terminal and then modifying the first communication terminal's role information to be compatible with its new role as a manager terminal role if the second password is correct.

Preferably, if the first or second password received from the user in step (a1) or (a3) is incorrect, step (a) is completed.

Preferably, if it turns out in step (a2) that the second communication terminal does not exist, role information of the first communication terminal is modified in step (a3) instead of transmitting the command to cancel setting of the second communication terminal as a manager terminal so that the first communication terminal can serve as a manager terminal.

Preferably, step (b) includes (b1) transmitting information on the central or local server point to each of the communications terminals, (b2) checking whether the central or local server point information is transmitted from the manager terminal, and (b3) storing the received central or local server point information if it is verified that the manager terminal transmits the central or local server point information.

Preferably, the method further includes (d) setting a fourth communication terminal, which is located closer than a third communication terminal currently serving as the central or local server to the central or local server point, as the central or local server.

According to another aspect of the present invention, there is provided a method of determining a relay server of a wireless communication network. The method includes (a) a first communication terminal obtaining its location coordinate values, receiving information on a central or local server point from a manager terminal which sets the central or local server point, and managing location information of each communication terminal, (b) the first communication terminal transmitting its location information and role information to neighboring communication terminals, (c) the first communication terminal receiving and storing location information and role information of the neighboring communication terminals, (d) the first communication terminal determining whether or not a communication terminal set as a central server exists among the neighboring communication terminals by analyzing the role information of the neighboring communication terminals, (e) the first communication terminal figuring out how far it is away from the central server point based upon its own location information and the location information of the neighboring communication terminal if there is no communication terminal set as a central server, and (f) the first communication terminal setting itself as a central server if it turns out to be located closest to the central server point.

Preferably, the method further includes (g) the first communication terminal selecting communication terminals belonging to the same communication region as it does from other communications terminals, (h) the first communication terminal determining whether or not a communication terminal currently serving as a local server exists among the selected communication terminals, (i) the first communication terminal figuring out how far it is from the local server point based upon its own location information and the location information of other communication terminal if there is no communication terminal currently serving as a local server, and (j) the first communication terminal setting itself as a local server if it turns out to be located closest to the local server point, if it turns out in step (e) that there exists a communication terminal currently serving as a central server or if it turns out in step (f) that there exists a communications terminal located closer than the first communication terminal to the central server point.

According to another aspect of the present invention, there is provided a method of replacing a relay server with another relay server over a wireless communication network. The method includes (a) a communication terminal currently serving as a central or local server receiving location information from other communication terminals, (b) the communication terminal checking if there exists among other communication terminals a first communication terminal located closer than it is to a central or local server point by analyzing the location information of other communication terminals, (c) the communication terminal transmitting a server setting command to set the first communication terminal as a new central or local server and server management information that it has managed to the first communication terminal and canceling information used for setting the communication terminal as a central or local server, and (d) the first communication terminal modifying its role information in response to the server setting command so that it can be set as a central or local server and storing the received server management information.

According to another aspect of the present invention, there is provided a communication method. The communication method includes (a) receiving location information of other communication terminals and storing the location information in a database, (b) searching the database for location information of a receiving terminal, which is a destination of data, (c) checking if a predetermined reference period of time has passed since, among the search results, most recent location information was recorded, and (d) transmitting the data to the receiving terminal based upon the most recent location information, if the predetermined reference period of time has not yet passed since the most recent location information was recorded.

Preferably, the method further includes (e) transmitting the data to a central server, (f) searching a terminal information table of the central server for the location information of the receiving terminal, and (g) the central server transmitting the data to a local server serving the searched location of the receiving terminal, if no search result has been obtained in step (b).

Preferably, the method further includes (h) searching the database for location information of the receiving terminal, which had been recorded directly before the most recent location information was recorded, (i) estimating location of the receiving terminal using the most recent location information and the previous location information, and (j) transmitting the data to a local server serving the estimated location of the receiving terminal, if the predetermined reference period of time has already passed since the most recent location information was recorded.

Preferably, the method further includes (k) transmitting the data to the central server, (l) searching the terminal information table of the central server for location information of the receiving terminal, and (m) transmitting the data from the central server to a local server serving the searched location of the receiving terminal, if no search result has been obtained in step (h).

According to another aspect of the present invention, there is provided a computer-readable recording medium, on which a program enabling the above-described method of determining a relay server of a wireless communication network is recorded.

According to another aspect of the present invention, there is provided a wireless communication system. The wireless communication system includes a manager terminal receiving a password from a user, authorizing the received password, and setting a central or local server point, and a plurality of communication terminals receiving the central or local server point from the manager terminal and storing the received central or local server point. Here, among the plurality of communication terminals, a communication terminal located closest to the central or local server point is set as a central or local server terminal performing a communication relay function.

According to another aspect of the present invention, there is provided a wireless communication terminal. The wireless communication terminal includes a transmission and receiving unit receiving point information including location information of neighboring communication terminals, and information on a central or local server point, and transmitting location information of the corresponding wireless communication terminal and data received from a user, a neighboring terminal information management unit storing the received location information of the neighboring communication terminals, a basic setting information management unit managing information on a communication terminal set as a central or local server terminal using role information of the wireless communication terminal, and the central or local server point information, a relay server setting unit setting the central or local server terminal based upon the central or local server point information, a data transmission control unit estimating location of a receiving terminal, which is a destination of data, and setting up a transmission path for transmitting the data received from the user to the receiving terminal, and an input and output unit outputting data received from the neighboring communication terminals and receiving data to be transmitted from the user.

According to another aspect of the present invention, there is provided a computer-readable recording medium having a data structure which includes a native code field where a unique code allotted to a communication terminal is recorded, a role information field where information on a role of the communication terminal over a communication network is recorded, and a point information field where information on a central or local server point used to set location of a central or local server over the communication network is recorded; and a data field where central or local server terminal information including a native code and location information of a communication terminal located closest to the central or local server point is recorded.

### BRIEF DESCRIPTION OF THE DRAWINGS

FIG. 1 is a diagram showing the arrangement of communication terminals for illustrating a method of determining a wireless relay server terminal according to a preferred embodiment of the present invention;

FIG. 2 is a flowchart of a method of establishing a wireless communication network according to a preferred embodiment of the present invention;

FIG. 3 is a flowchart of a method of determining a manager terminal according to a preferred embodiment of the present invention;

FIG. 4 is a flowchart of a method of setting up a central or local server point for each communication terminal according to a preferred embodiment of the present invention;

FIG. 5A is a flowchart of a method of determining a communication terminal as a central or local server according to a preferred embodiment of the present invention;

FIG. 5B is a flowchart of a method of replacing a communication terminal currently serving as a central or local server with another communication terminal according to a preferred embodiment of the present invention;

FIG. 6 is a diagram illustrating a method of estimating the locations of communication terminals according to a preferred embodiment of the present invention;

FIG. 7A is a flowchart of a communication method of an ordinary communication terminal or a local server terminal according to a preferred embodiment of the present invention;

FIG. 7B is a flowchart of a communication method of a central server terminal according to a preferred embodiment of the present invention;

FIG. 8A is a table showing basic information of a communication terminal according to a preferred embodiment of the present invention;

FIG. 8B is a table showing basic information on communication terminals adjacent to a predetermined communication terminal according to a preferred embodiment of the present invention;

FIG. 8C is a table showing basic information on communication terminals adjacent to a predetermined communication terminal according to another preferred embodiment of the present invention; and

FIG. 9 is a diagram illustrating a communication terminal according to a preferred embodiment of the present invention.

### BEST MODE FOR CARRYING OUT THE INVENTION

Hereinafter, the present invention will be described more fully with reference to the accompanying drawings in which preferred embodiments of the invention are shown.

In order to enable a plurality of communication terminals distributed over a large area to communicate with one another while they are moving, a relay server serving a predetermined region, i.e., a relay base station, must be provided. However, in a case where such relay server is fixed to a predetermined location, it often fails to seamlessly provide relay services to the moving communication terminals. Therefore, in the present invention, all communication terminals are designed to have a relay function, and a communication terminal closest to a predetermined server point is set to serve as a relay server. The server point is represented by absolute coordinate values consisting of a longitude coordinate value and a latitude coordinate value, and each of the communication terminals receives a global positioning system (GPS) signal, generates its location information, and transmits the location information to its adjacent communication terminal. Accordingly, adjacent communication terminals share their location information.

Therefore, in the present invention, a predetermined communication terminal always serving as a relay server does not exist. Rather, in the present invention, a communication terminal closest to a predetermined server point temporarily serves as a relay server. In other words, if an arbitrary communication terminal comes very close to a place that is set as a server point while moving around, then the communication terminal temporarily serves as a relay server. After a while, if another communication terminal appears to be closer than the communication terminal currently serving as a relay server to the server point, it becomes a new relay server. This manner makes it possible to maintain a wireless communication network irrespective of replacement of a communication terminal serving as a relay server with another communication terminal. In addition, each communication terminal can carry out communications with another communication terminal in a remote area via a local server or a central server.

In the meantime, in the present invention, a communication terminal acting as a manager terminal sets up central and local server point values. The manager terminal receives information on communication terminal collected by each local server from a central server.

Hereinafter, a wireless communication network having a hierarchical structure comprised of a manager terminal, a central server terminal, local server terminals, and communication terminals will be described as an example of the present invention for the convenience of explanation. However, the number of levels constituting the hierarchy may increase or decrease, if necessary. In other words, local server terminals are divided into a first local server terminal serving as a relay server between a second local server terminal and a central server terminal and a second local server terminal serving as a relay server between a first local server terminal and other communication terminals.

In the present invention, a communication terminal closest to a central server point serves as a central server terminal. The central server terminal stores and manages data of all communication terminals belonging to the same communication group as it does. The data include identification (ID) codes and location information of the communication terminals. In addition, the central server terminal processes a request made by a local server terminal or a communication terminal for searching for communication terminals within its coverage. The central server terminal transmits a command received from a manager terminal to the local server terminal and communication terminals and transmits collected information on the communication terminals to the manager terminal. The central server terminal may store information on the location of the manager terminal.

In the present invention, a communication terminal closest to the location of a local server, i.e., a local server point, serves as a local server terminal. The local server terminal serves a predetermined region, collects information on the locations of communication terminals in the predetermined region, and transmits the information to a central server terminal. The local server terminal receives a communication terminal's request for information on the location of another communication terminal. Thereafter, the local server terminal responds to the request of the communication terminal by searching its own data for the requested information or obtaining the requested information from another local or central server.

In the present invention, the location of a central server, i.e., a central server point, and the location of a local server, i.e., a local server point, are set by the manager terminal. There is only one central server for a predetermined network, and information on the location of the central server is represented by the latitude and longitude coordinate values. On the other hand, there exists a plurality of local servers for the central server. The local servers are arranged in a regular manner centering around the central server point so that two longitudinally or latitudinally adjacent local servers are a predetermined distance apart. For example, supposing that the latitude and longitude coordinate values of the central server point are 35°5′ and 127°5′, respectively, and the predetermined distance is set to 2′ in either a latitudinal direction or a longitudinal direction, local server point coordinate values can be obtained by adding/subtracting 2′ a predetermined number of times to/from either the latitude coordinate value or longitude coordinate value of the central server or both of the two coordinate values. Accordingly, local sever points represented by (35°5′, 127°7′), (35°5, 127°9′), . . . , (35°7′, 127°7′), and (35°7′, 127°9′) are obtained. Here, the predetermined distance between two longitudinally or latitudinally adjacent local servers may be set to a different value.

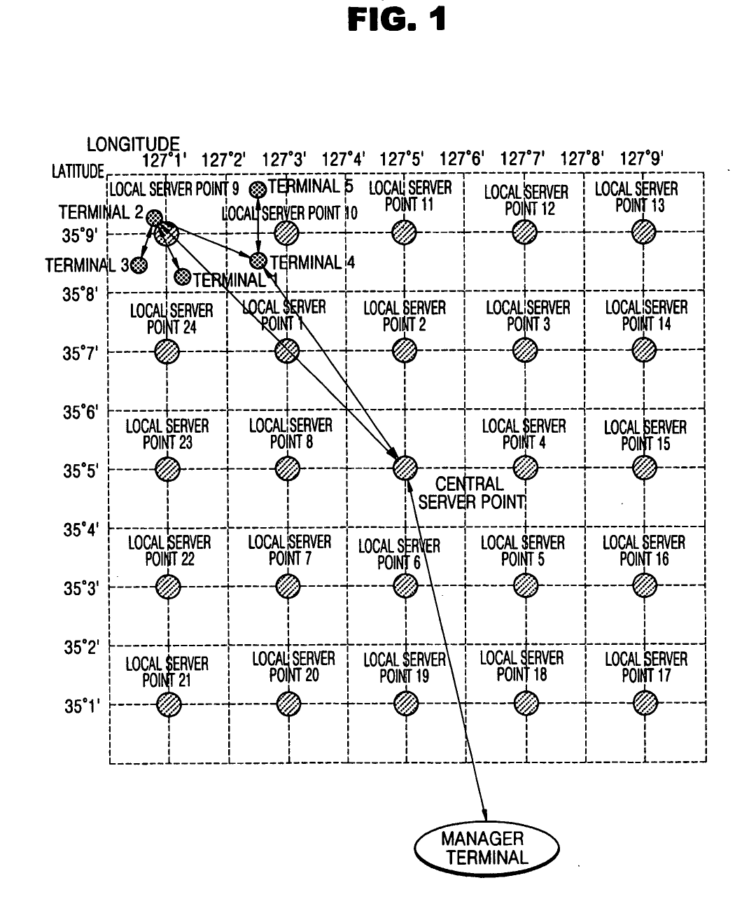

FIG. 1 is a diagram showing the arrangement of communication terminals for illustrating a method of determining local server terminals according to a preferred embodiment of the present invention. Referring to FIG. 1, a terminal 1 identifies its location coordinates in real time using a GPS technique or other methods. The location of the terminal 1 is represented by an ordered pair (35°8′10″, 127°1′9″). Here, let us assume that the location of a central server, i.e., a central server point, is represented by an ordered pair (35°5′, 127°5′) and a distance between two longitudinally or latitudinally adjacent local servers is set to 2′. A difference between the ordered pair of the terminal 1 and the ordered pair of the central server is (0°3′10″, −0°3′51″). Based on the distance between two longitudinally or latitudinally adjacent local servers, it is possible to figure out that the terminal 1 is located in a communication region which is two regions to the west and two to the north from a communication region where the central server belongs. Therefore, the location of a local server in the communication region where the terminal 1 is located can be calculated based on the coordinate values of the central server point. In other words, an ordered pair (35°9′, 127°1′) representing the location of the corresponding local server is obtained by adding 4′ to the latitude coordinate value of the central value and subtracting 4′ from the longitude coordinate value of the central value.

A method of determining a central or local server terminal in a communication region is as follows. The terminal 1 records data received from all communication terminals within a communicable range in a neighboring-terminal-information table. The data includes the communication terminals' ID codes, role information, and location coordinates. By doing so, the terminal 1 can figure out that there are two more communication terminals, i.e., a terminal 2 and a terminal 3, in the corresponding communication region and there is no communication terminal determined as a local server terminal in the corresponding communication region. In this case, among the three terminals 1 through 3, the terminal 2 which is closest to a local server point 9 is determined as a local server terminal serving the corresponding communication region.

Referring to FIG. 1, the location of the central server, i.e., the central server point, is represented by (35°5′, 127°5′), and two longitudinally or latitudinally adjacent local servers have a distance of 2′ therebetween. According to the above-described method of determining a central or local serve terminal in a communication region, the terminal 2 and a terminal 4 are determined as local server terminals serving their corresponding communication regions. Here, the terminals 1, 3, and 5 that are not determined as local server terminals are called ordinary terminals. The ordinary terminals 1 and 3 are connected to the local server terminal 2, and the ordinary terminal 5 is connected to the local server terminal 4.

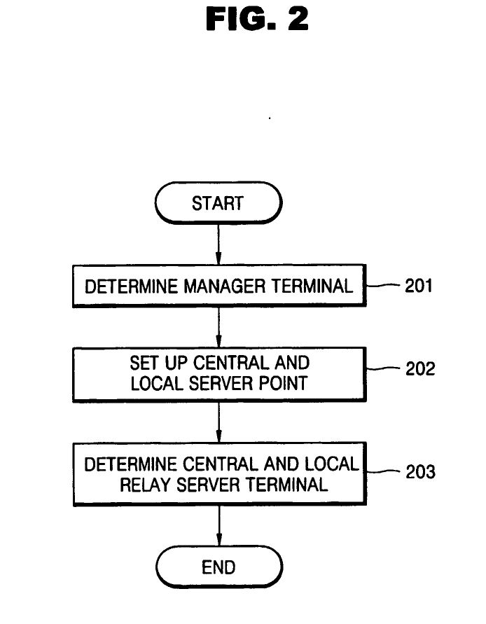

FIG. 2 is a flowchart of a method of establishing a wireless communication network according to a preferred embodiment of the present invention. Referring to FIG. 2, a manager terminal is determined in step 201, and then central local server points are assigned to communication terminals belonging to the same communication group as the manager terminal in step 202. Thereafter, a central or local server terminal is determined in step 203 using the above-described method of determining a central or local server terminal in a communication region. In this manner, a wireless communication network, like the one shown in FIG. 1, is completed in the end.

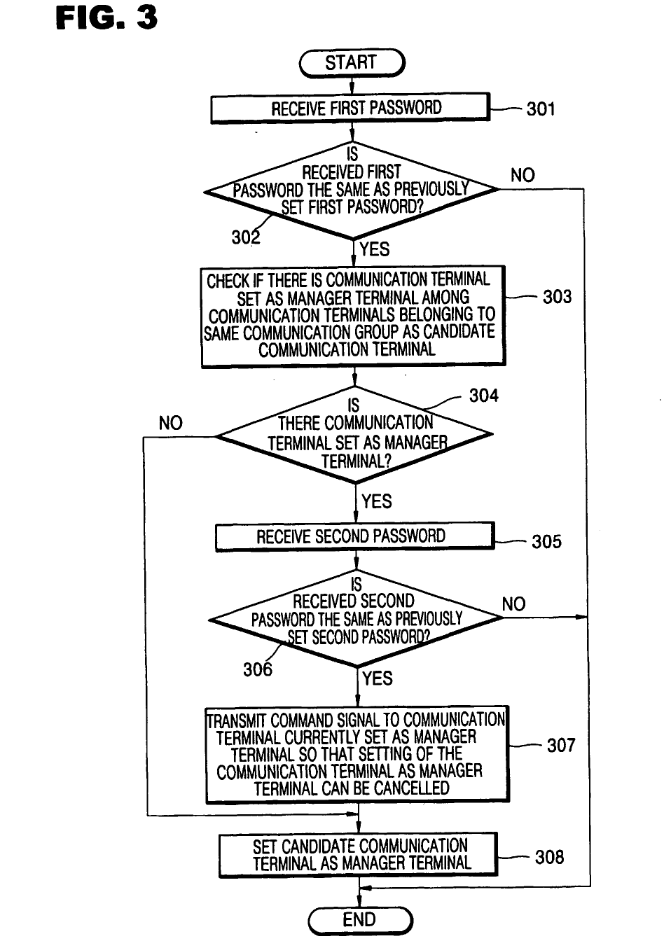

FIG. 3 is a flowchart of a method of determining a user terminal according to a preferred embodiment of the present invention. Hereinafter, a communication terminal performing a process of setting up a manager terminal will be called a candidate communication terminal.

Referring to FIG. 3, the candidate communication terminal receives a first password from a user in step 301 and then checks if the received first password is correct in step 302 based on information on the first password stored in advance in the candidate communication terminal. If the received first password turns out to be correct, the candidate communication terminal checks whether or not there is a communication terminal already set as a manager terminal, among communication terminals belonging to the same communication group as the candidate communication terminal, in step 303. Step 303 is carried out by receiving and analyzing information on the roles of all the communication terminals belonging to the same communication group as the candidate communication terminal.

In a case where there is more than one communication terminal set as a manager terminal, the candidate communication terminal receives a second password from the user in step 305 and then checks if the received second password is correct in step 306 based on information on the second password stored in advance in the candidate communication terminal. If the received second password turns out to be correct, the candidate communication terminal transmits a command signal to a communication terminal being currently set as a manager terminal in so that setting of the communication terminal as a manager terminal can be cancelled. Thereafter, the candidate communication terminal modifies its role information so as to serve as a manager terminal in step 308. If it turns out in step 304 that there is no communication terminal set as a manager terminal, the method directly moves onto step 308. In addition, if the received first password and the received second password turn out in steps 302 and 306, respectively, to be incorrect, the whole process is completed. In steps 302 and 306, various methods including finger print recognition and iris recognition other than passwords consisting of several numbers or characters can be used for authentication in steps 302 and 306.

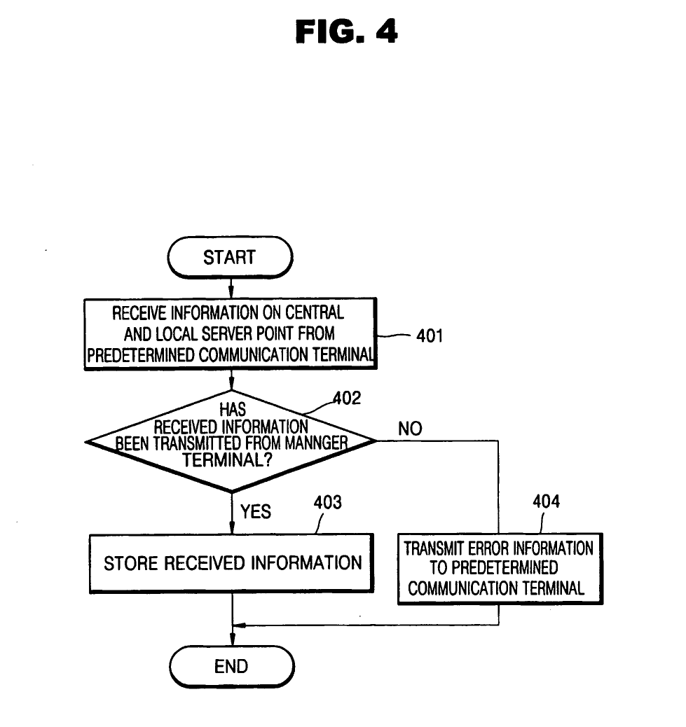

FIG. 4 is a flowchart of a method of setting up a central or local server point for each terminal according to a preferred embodiment of the present invention. In particular, FIG. 4 shows that each communication terminal receives a central or local server point value from a communication terminal set as a manager terminal and then stores the received central or local server point value.

Referring to FIG. 4, a communication terminal receives information on a central or local server point in step 401. Thereafter, in step 402, the communication terminal determines whether or not the information is transmitted from a manager terminal by analyzing the identification code and role information of a predetermined communication terminal that has transmitted a message included in the received information. If the received information is transmitted from the manager terminal, the communication terminal stores the received information in step 403. However, if the received information is not transmitted from the manager terminal, the communication terminal sends error information to the predetermined communication terminal transmitting the central or local server point information in step 404. In this case, the communication terminal scraps the received information rather than storing it.

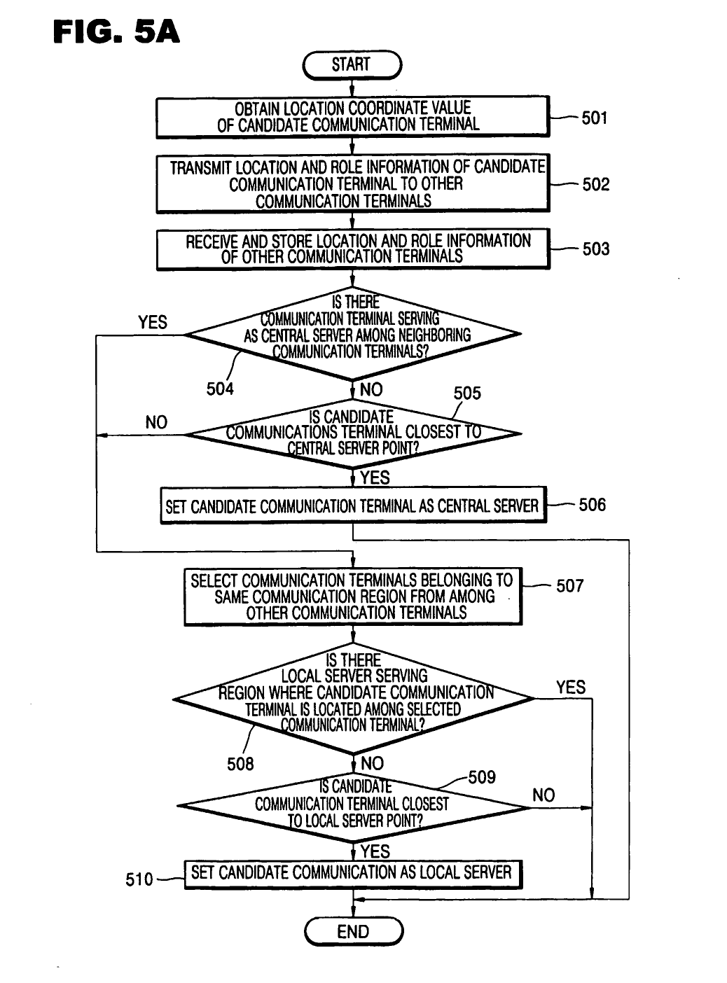

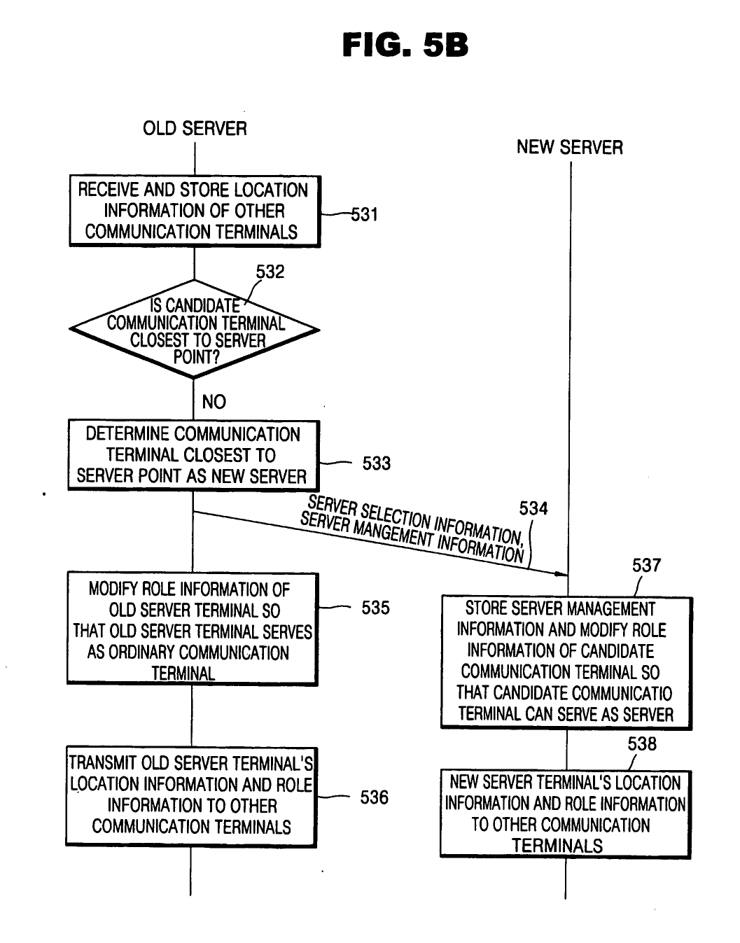

FIG. 5A is a flowchart of a method of determining a communication terminal as a central or local server terminal according to a preferred embodiment of the present invention. Hereinafter, a communication terminal performing a process of setting a central or local server terminal will be called a candidate communication terminal.

Referring to FIG. 5A, the candidate communication terminal obtains its location coordinate values using a GPS signal in step 501 and then transmits the obtained information and its role information to neighboring communication terminals in step 502. Here, the role information of the candidate communication terminal shows that the candidate communication terminal is set as an ordinary communication terminal. Thereafter, the candidate communication terminal receives ID codes, role information, and location information of the neighboring communication terminals and records the received information in a neighboring-terminal-information table in step 503. Thereafter, in step 504, the candidate communication terminal checks if there exists a communication terminal serving as a central server among the neighboring communication terminals by searching the neighboring-terminal-information table. If it is verified that there is no communication terminal serving as a central server among the neighboring communication terminals, the candidate communication terminal verifies in step 505 if it is closest to a central server point based on the location information of the neighboring communication terminals. If the candidate communication terminal turns out to be closest to the central server point, the candidate communication terminal sets itself as a central server terminal modifying its role information in step 506.

In step 504, however, if it turns out that there exists a communication terminal serving as a central server among the neighboring communication terminals, the candidate communication terminal selects communication terminals belonging to the same communication region as the candidate communication terminal from among the neighboring communication terminal in step 507. Thereafter, in step 508, the candidate communication terminal checks if there exists, among the selected communication terminal, a local server terminal serving the communication region where the candidate communication terminal belongs. If there is no local server terminal in the corresponding communication region, the candidate communication terminal verifies in step 509 if it is closest to a local server point based on the location information of the communication terminals selected in step 507. If the candidate communication terminal turns out to be closest to the local server point, it sets itself as a local server terminal in step 510. On the other hand, in step 508, if it turns out in step 508 that there is a communication terminal already set as a local server or if it turns out in step 509 that there exists another communication terminal closer than the candidate communication terminal to the local sever point, the process of setting a local server is completed.

FIG. 5B is a flowchart of a method of replacing a communication terminal currently serving as a central or local server with another communication terminal according to a preferred embodiment of the present invention. In particular, FIG. 5B shows that a moving central or local server terminal is replaced by another moving communication terminal closest to a central or local server point at a given moment. Here, the communication terminal that used to serve as a central or local server until being replaced by another communication terminal will be called an old server, and the communication terminal that replaces the old server to become a new central or local server terminal will be called a new server.

In step 531, the old server receives location information of neighboring communication terminals periodically or in real-time, stores the received location information in a neighboring-terminal-information table, and manages the stored information. In step 532, the old server checks if it is the communication terminal closest to a central or local server point by comparing its own location information with the location information received from the neighboring communication terminals. If it turns out that there exists another communication terminal closer than the old server to the central or local server point, the corresponding communication terminal is set as a new server in step 533. Then, the old server transmits server selection information used for commanding the new server to newly set its role information to be appropriate for its new role, i.e., a server, and server management information to the corresponding communication terminal determined as a new server in step 534. Here, the server management information used to be managed by the old server until being transmitted to the new server and includes information on the neighboring communication terminal. In a case where the old server and the new server are local servers, the server management information further includes information on a central server. On the other hand, if the old server and the new server are central servers, the server management information further includes information on a manager terminal. The corresponding communication terminal can replace the old server only when it maintains its location to be closer than the old server to the server point for more than a predetermined amount of time.

Next, the old server changes its role information to be appropriate for its new role as an ordinary communication terminal in step 534 and then transmits its newly changed role information and location information to the neighboring communication terminals in step 536. In step 537, the new server also changes its role information to be appropriate for its new role as a server and stores the server management information received from the old server. Thereafter, the new server transmits its newly changed role information and location information to the neighboring communication terminals in step 538.

In the meantime, in a case where the old (central or local) server abruptly breaks down and thus cannot perform its functions well, a new central or local server is determined by using the method shown in FIG. 5A.

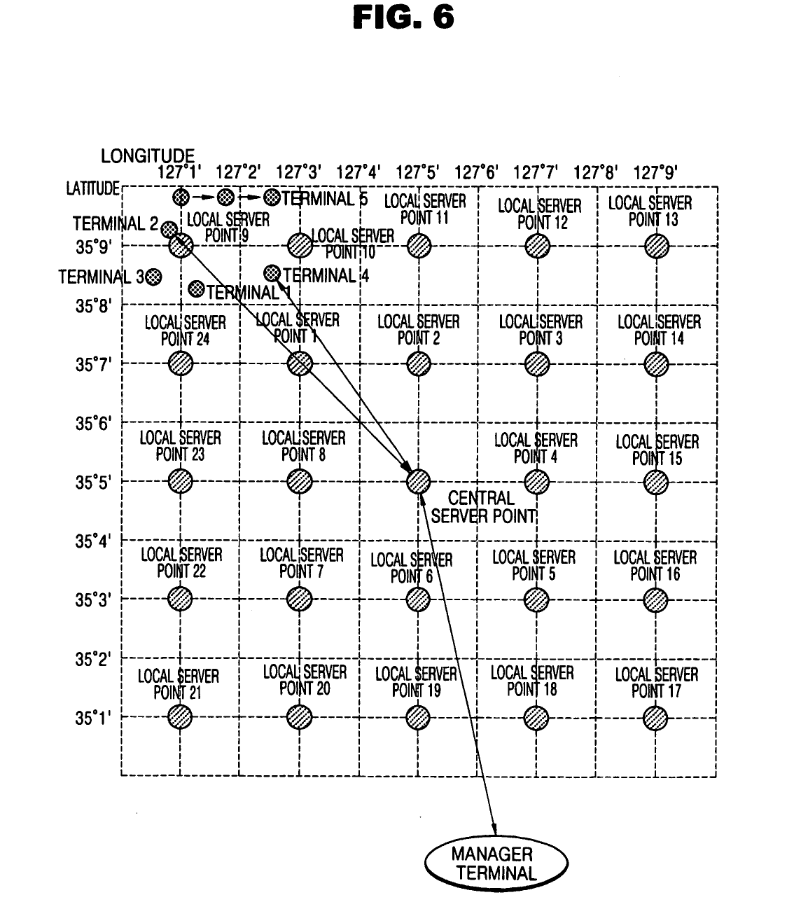

FIG. 6 is a diagram illustrating a method of estimating the location of a communication terminal according to a preferred embodiment of the present invention. A wireless communication network shown in FIG. 6 is the same as the one shown in FIG. 1 except that a terminal 5 moves from a local server point 9 where a terminal 2 is set as a local server to a local server point 10 where a terminal 4 is set as a local server. In particular, FIG. 6 shows a process of estimating the location of the terminal 5.

Each communication terminal transmits its ID, location information, and role information to its neighboring communication terminals or local server terminal periodically or in real-time, even when it moves away from its original location by more than a predetermined distance. The local server terminal receives the ID, location information, and role information of each of the communication terminals, stores the received information in a neighboring-terminal-information table, and transmits the received information to a central server terminal. The central server terminal stores the information received from the local server terminal and transmits the received information to a manager terminal.

Data can be transmitted from a communication terminal, i.e., a sending terminal, to another communication terminal, i.e., a receiving terminal, over a wireless communication network according to a preferred embodiment of the present invention by using location information of the sending terminal. In other words, if the receiving terminal is placed within a communicable range of the sending terminal, the sending terminal directly transmits data to the receiving terminal. On the other hand, if the receiving terminal is placed beyond the communicable range of the sending terminal, the sending terminal directly transmits a data relay request message and the data desired to be transmitted to the receiving terminal to a local server which is located closest to the receiving terminal. Then, the local server directly transmits the received data to the receiving terminal if the receiving terminal is located within a communicable range of the local server. If the receiving terminal is located beyond the communicable range of the local server, the local server transmits a data relay request message and the data desired to be transmitted to the receiving terminal to another local server which is a local server which is located closest to the receiving terminal. This process enables a communication terminal to communicate with another communication terminal in a remote area.

In short, in order to transmit data to a predetermined communication terminal, i.e., a receiving party, in the present invention, the location of the predetermined communication terminal is necessary. In order to figure out where the receiving terminal is located, a sending terminal searches its neighboring-terminal-information table first. If the location of the receiving terminal is not identified, the sending terminal requests a local server the location information of the receiving terminal from. In a case where even the local server cannot figure out the location of the receiving terminal, it requests a central server the corresponding information. Thereafter, the local server estimates a direction along which the receiving terminal has moved or the current location of the receiving terminal using old location information of the receiving terminal stored in its neighboring-terminal-information table. In addition, the local server makes a request for the current location information of the receiving terminal to another local server serving a predetermined region where the receiving terminal is expected to be

Hereinafter, the process of estimating a receiving terminal will be described in greater detail with reference to FIG. 6.

A local server terminal searches its neighboring-terminal-information table for location information of a receiving terminal. If the location information of the receiving terminal is searched for and is considered relatively new because a predetermined reference period of time has not yet passed since the searched location information was recorded last, the local server terminal transmits data desired to be transmitted to the receiving terminal using the searched location information. However, if the searched location information is not new because the predetermined reference period of time has already passed since the searched location information was recorded last, the local server terminal searches the neighboring-table-information table again for previous location information of the receiving terminal. By doing so, the local server terminal obtains two pieces of information, i.e., two different locations of the receiving terminal at two different moments of time. The local server terminal calculates the migration direction and speed of the receiving terminal based on the two pieces of information and then estimates the location of the receiving terminal (at a given moment) in consideration of the calculated migration direction and speed of the receiving terminal.

Thereafter, the local server terminal transmits the data desired to be transmitted to another local server terminal serving a predetermined region where the receiving terminal is expected to be based on the migration direction and speed. For example, let us assume that the receiving terminal was located at a place represented by (35°8′, 127°1′) at 17:20:21 and at a place represented by (35°8′, 127°2′) at 17:20:51. In this case, the receiving terminal had moved to the east by as much as 1′ for 30 seconds, which means the receiving terminal had moved to the east at a speed of 216 km/h. Here, let us assume that 1′ in a longitudinal direction accounts for about 1.8 km. Therefore, the receiving terminal is expected to be at a place represented by (35°8′, 127°3′) at 17:21:21, and thus in order for the sending terminal to transmit the data to the receiving terminal at 17:21:21, the sending terminal is required to transmit the corresponding data first to a local server serving the place represented by (35°8′, 127°3′) where the receiving terminal is expected to be.

Referring to FIG. 6, the terminal 2 serving as a local server receives location information of the moving terminal 5 periodically or in real-time and stores the received location information in its neighboring-terminal-information table. After a while, the terminal 5 goes beyond a communication region served by the local server, i.e., the terminal 2. At this time, a terminal 1 or 3 makes a request for current location information of the terminal 5 to the terminal 2 in order to transmit predetermined data to the terminal 5. Then, the terminal 2 estimates the current location of the terminal 5 using the stored location information of the terminal 5. Based on the result of the presumption, the terminal 2 makes a request for current location information of the terminal 5 to the terminal 4. Here, the process of estimating the location of a communication terminal is performed by a local server. However, if necessary, an ordinary communication terminal is also allowed to perform the corresponding process.

In the meantime, if it is impossible to obtain sufficient information necessary to estimate the location of the receiving terminal, the terminal 2 makes a request for the location information of the terminal 2 to a central server terminal.

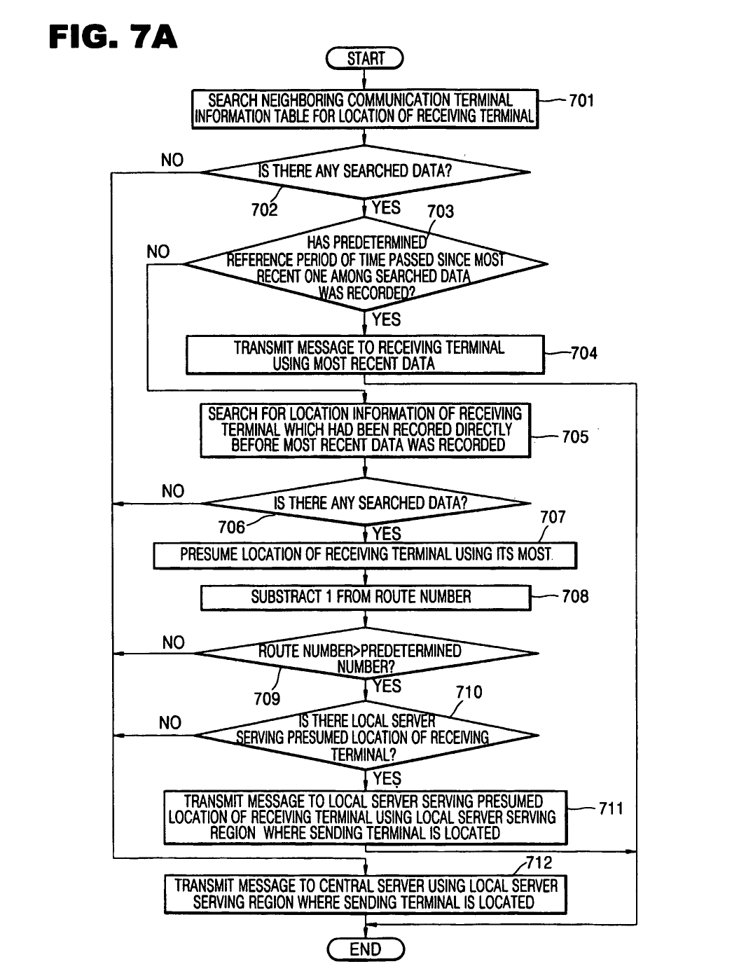

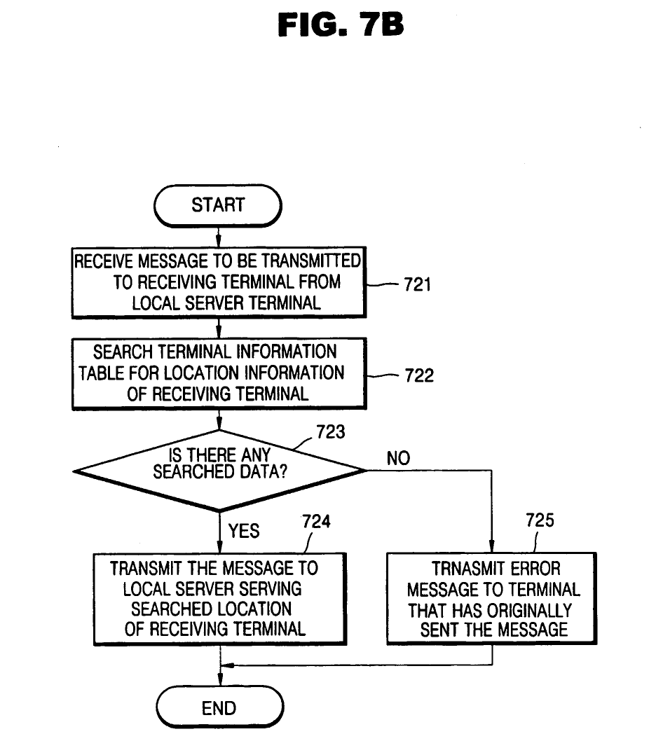

FIG. 7A is a flowchart of a communication method of an ordinary communication terminal or a local server terminal according to a preferred embodiment of the present invention.

Referring to FIG. 7A, a sending terminal searches its own neighboring-terminal-information table for location information of a receiving terminal in step 701. When the location information of the receiving terminal is searched for, the sending terminal checks in step 703 if a predetermined reference period of time has already passed since the most recent one among the searched location information was recorded. If the predetermined reference period of time has not yet passed since the most recent location information was recorded, the sending terminal transmits predetermined data to the receiving terminal based upon the most recent location information of the receiving terminal.

However, if the predetermined reference period of time has already passed since the most recent location information was recorded, the sending terminal searches the neighboring-terminal-information table for another location information which had been recorded directly before the most recent location information was recorded, in step 705. The sending terminal checks if there exists the result of the search in step 706. If there is the result of the search, the sending terminal estimates the current location or migration direction of the receiving terminal based on the most recent location information and the previous one in step 707. Thereafter, the sending terminal subtracts 1 from the number of routes, which has been set in advance, in step 708. Thereafter, the sending terminal determines if the result of the subtraction is greater than a reference value in step 709. If the result of the subtraction is greater than the reference value, the sending terminal determines whether or not there exists a local server terminal serving the estimated location of the receiving terminal in step 710. If there is a local server terminal serving the estimated location of the receiving terminal, the sending terminal transmits the predetermined data, via its local server terminal, to the local server terminal serving the estimated location of the receiving terminal. Here, the process of estimating the location of the receiving terminal is assumed to have been performed by an ordinary communication terminal.

In the meantime, if there is no search result obtained in step 702 or 706, if the result of the deduction performed in step 708 is smaller than the predetermined reference number, or if there is no local server terminal serving the estimated location of the receiving terminal, the sending terminal transmits the predetermined data to a central server via its local server in step 712.

FIG. 7B is a flowchart of a communication method of a central server terminal according to a preferred embodiment of the present invention. In particular, FIG. 7B shows a process of processing a communication message performed by a central server terminal in a case where a sending terminal transmits predetermined data to the central server terminal, as described above with reference to FIG. 7A.

Referring to FIG. 7A, a central server terminal receives a message or data to be transmitted to a receiving terminal from a local server terminal in step 721 and then searches its own neighboring-terminal-information table for location information of the receiving terminal in step 722. If the location information of the receiving terminal is searched for, the central server terminal transmits the message or data to a local server terminal serving the searched location of the receiving terminal in step 724. On the other hand, if no location information is searched for, the central server terminal transmits an error message to a sending terminal in step 725.

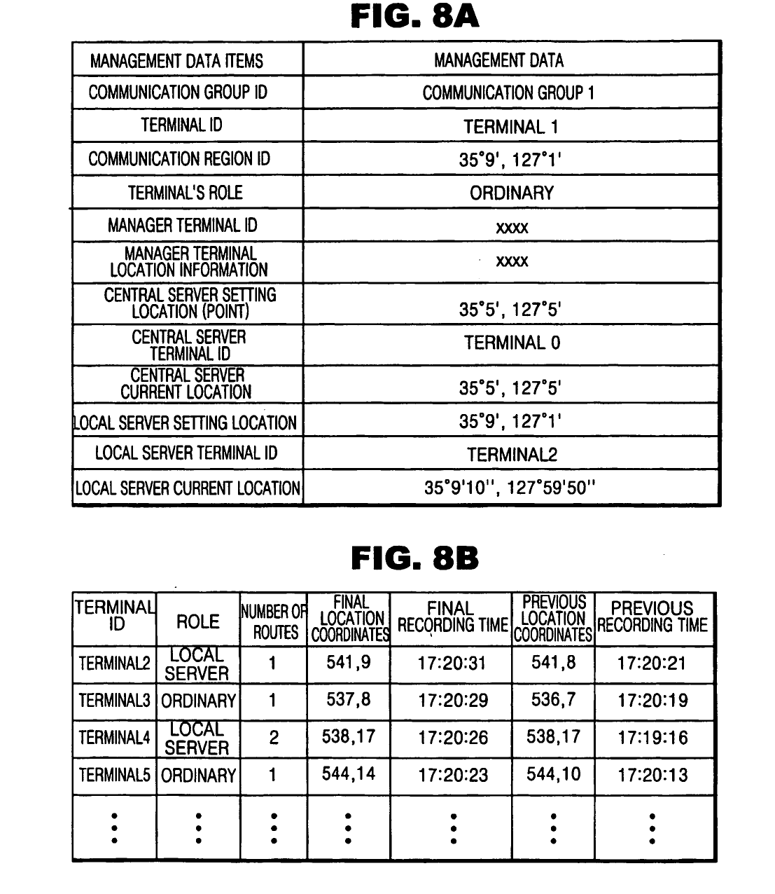

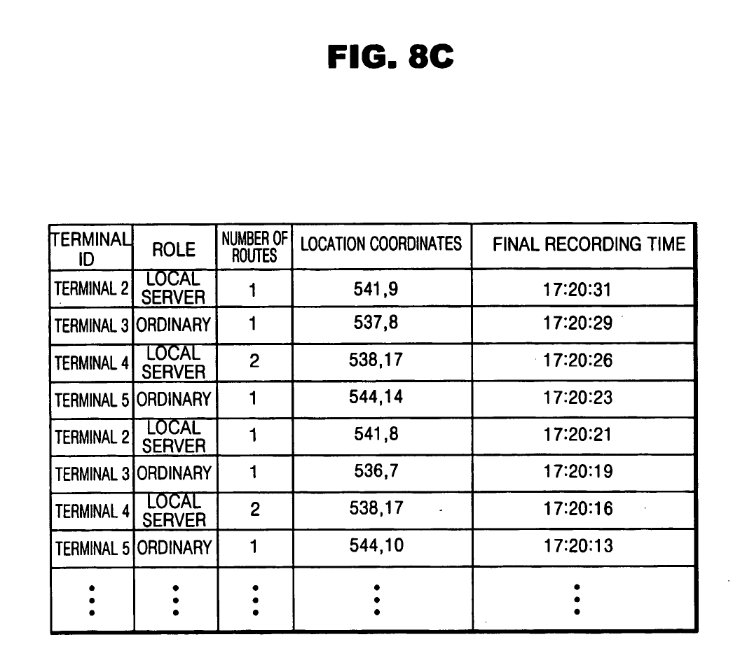

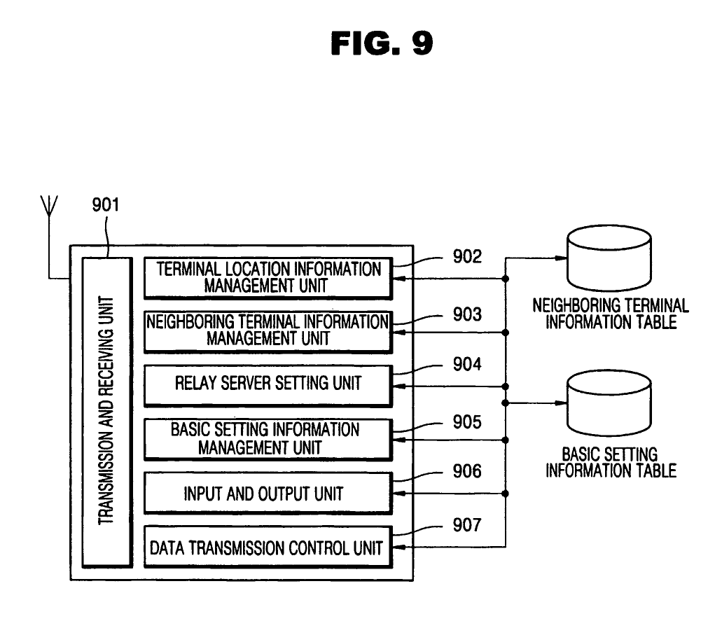

FIG. 8A is a table showing basic information on a communication terminal according to a preferred embodiment of the present invention. In FIG. 8A, communication group ID represents an ID code necessary to differentiate a group of communication terminals controlled by one manager terminal from other communication terminal groups controlled by other manager terminals, and terminal ID represents an ID code necessary to differentiate a communication terminal belonging to a predetermined communication group from others in the predetermined communication group, and communication region ID represents an ID code necessary to differentiate a predetermined communication region served by one local server terminal from other communication regions. Here, the communication region ID may be considered as a local server point value. Communication terminals are divided based upon their roles into ordinary communication terminals, local server terminals, central server terminals, and user terminals. However, if necessary, the number of levels constituting such hierarchy of a wireless communication network may increase. In FIG. 8A, manager terminal ID indicates an ID code necessary to differentiate a communication terminal determined as a manager terminal from other communication terminal. The manager terminal ID can only be stored in a central server terminal. In addition, user terminal location information is information on the location of a manager terminal. The user terminal location information can only be stored in the central server terminal.

A central server setting location (position) indicates location information of a central server set by the manager terminal. Central server terminal ID indicates ID of a communication terminal currently serving as a central server, and central server current location indicates information on the current location of the communication terminal currently serving as a central server. A local server setting location (point) indicates location information of a local server point set by the manager terminal. Here, the location information of a local server indicates how far the local server is from a central server point in terms of both latitude and longitude. In addition, local server terminal ID indicates ID of a communication terminal being closest to a local server point and thus currently serving as a local server, and local server current location indicates information on the current location of the communication terminal currently serving as a local server.

FIG. 8B is a table showing information on communication terminals surrounding a predetermined communication terminal according to a preferred embodiment of the present invention. In FIG. 8B, terminal ID and role information are the same as their counterparts shown in FIG. 8A. The number of routes indicates how many routes are necessary to transmit data from a predetermined communication terminal to a target communication terminal. Route number information can be obtained by figuring out how many relaying steps are taken to transmit data from the predetermined communication terminal to the target communication terminal. The number of relaying steps can be figured out by comparing a route number initially set before the predetermined communication terminal transmits predetermined data to the target communication terminal with the number of routes identified based on the data received by the target communication terminal.

FIG. 8C is a table showing information on communication terminals surrounding a predetermined communication terminal according to another preferred embodiment of the present invention. In FIGS. 8B and 8C, the location of a communication terminal is not represented by latitudinal and longitudinal coordinates but a predetermined rational value obtained through calculation using the latitudinal and longitudinal coordinates.

FIG. 9 is a diagram illustrating a communication terminal according to a preferred embodiment of the present invention. Referring to FIG. 9, the communication terminal includes a transmission and receiving unit 901, a terminal location information management unit 902, a neighboring terminal information management unit 903, a basic setting information management unit 904, a relay server setting unit 905, an input and output unit 906, and a data transmission control unit 907.

The transmission and receiving unit 901 transmits/receive necessary signals to/from neighboring communication terminals over a wireless communication network. The terminal location information management unit 902 receives a GPS signal, generates location on its current location, and stores the current location information in a basic setting information table. The neighboring terminal information management unit 903 receives ID, location information, role information, and route number information of communication terminals surrounding the corresponding communication terminal from the transmission and receiving unit 901, stores the received information in a neighboring terminal information table shown in FIG. 8B or 8C, and manages the stored information. The basic setting information management unit 904 manages information including communication group ID, terminal ID, communication region ID, terminal role information, user terminal ID, user terminal location information, central server setting location (point), central server terminal ID, central server current location, local server setting location (point), local server terminal ID, and local server current location, as shown in FIG. 8A. In particular, the neighboring terminal information management unit 903 receives the communication group ID and the terminal ID from a user. The communication region ID is generated based upon local server point information, and the terminal role information is generated by the relay server setting unit 905. In addition, the neighboring terminal information management unit 903 obtains the manager terminal ID, the manager terminal location information, the central server setting location, and the local server setting location from the manager terminal ID and then stores the received information. In addition, the neighboring terminal information management unit 903 receives the central server terminal ID and the central server terminal current location from a central server terminal and then stores the received information. Finally, the neighboring terminal information management unit 903 receives the local server terminal ID and the local server current location from a local server terminal and then stores the received information.

The relay server setting unit 905 sets the corresponding communication terminal as a central or local server terminal, which has been described above with reference to FIG. 5A. The input and output unit 906 provides messages transmitted from other communication terminals and a variety of information on the corresponding communication terminal to the user and receives messages to be transmitted to other communication terminals from the user. The data transmission control unit 907 estimates the location of a receiving terminal, which has been described above with reference to FIGS. 6 and 7A, and sets up a transmission path along which the messages received from the user can be transmitted to a receiving terminal.

The present invention can be embodied as a computer-readable program that can be processed in a digital computer using a predetermined recording medium. In addition, the data structure proposed in the present invention can also be embodied as codes that can be processed in a digital computer using a computer-readable recording medium. Here, the computer-readable recording medium can be a magnetic storage medium, such as a ROM, a floppy disk, or a hard disk, or an optical recording medium, such as a CD-ROM or a DVD, or a carrier wave, for example, transmission through the Internet.

While this invention has been particularly shown and described with reference to preferred embodiments thereof, it will be understood by those skilled in the art that various changes in form and details may be made therein without departing from the spirit and scope of the invention as defined by the appended claims.

### INDUSTRIAL APPLICABILITY

According to the present invention, it is possible to provide, without establishing a physically fixed relay base station or an access point, the same effect as that of establishing a relay station for a communication terminal keeping changing its location. In addition, even when a communication terminal serving a relay server breaks down or is destroyed, it is possible to maintain a stable wireless communication network providing seamless communication services. In the present invention, in a case where the location of a target communication terminal to which data will be transmitted is not identified, the data is transmitted first to a local server serving a estimated location of the target communication terminal. Therefore, it is possible to prevent communication load from being excessively concentrated on a central server terminal.

1. A method of establishing a wireless communication network, comprising:
(a) determining a manager terminal, which selects central and local servers from among a plurality of communication terminals and receives and manages location information of each of the communication terminals;
(b) setting a central or local server point using the manager terminal; and
(c) determining a communication terminal closest to the central or local server point as a central or local server.

2. The method of claim 1, wherein step (a) comprises:
(a1) authorizing a first password input from a user;
(a2) checking whether or not there exists a second communication terminal, which has already been set as a manager terminal, among communication terminals belonging to the same communication group as a first communication terminal which is determined as the manager terminal, if the first password is correct;
(a3) receiving a second password from the user and authorizing the second password if there exists the second communication terminal; and
(a4) transmitting a command to cancel setting of the second communication terminal as a manager terminal to the second communication terminal and then modifying the first communication terminal's role information to be compatible with its new role as a manager terminal role if the second password is correct.

3. The method of claim 2, wherein if the first or second password received from the user in step (a1) or (a3) is incorrect, step (a) is completed.

4. The method of claim 2, wherein if it turns out in step (a2) that the second communication terminal does not exist, role information of the first communication terminal is modified in step (a3) instead of transmitting the command to cancel setting of the second communication terminal as a manager terminal so that the first communication terminal can serve as a manager terminal.

5. The method of claim 1, wherein step (b) comprises:
(b1) transmitting information on the central or local server point to each of the communications terminals;
(b2) checking whether the central or local server point information is transmitted from the manager terminal; and
(b3) storing the received central or local server point information if it is verified that the manager terminal transmits the central or local server point information.

6. The method of claim 1 further comprising:
(d) setting a fourth communication terminal, which is located closer than a third communication terminal currently serving as the central or local server to the central or local server point, as the central or local server.

7. A method of determining a relay server of a wireless communication network, comprising:
(a) a first communication terminal obtaining its location coordinate values, receiving information on a central or local server point from a manager terminal which sets the central or local server point, and managing location information of each communication terminal;
(b) the first communication terminal transmitting its location information and role information to neighboring communication terminals;
(c) the first communication terminal receiving and storing location information and role information of the neighboring communication terminals;
(d) the first communication terminal determining whether or not a communication terminal set as a central server exists among the neighboring communication terminals by analyzing the role information of the neighboring communication terminals;
(e) the first communication terminal figuring out how far it is away from the central server point based upon its own location information and the location information of the neighboring communication terminal if there is no communication terminal set as a central server; and
(f) the first communication terminal setting itself as a central server if it turns out to be located closest to the central server point.

8. The method of claim 7 further comprising:
(g) the first communication terminal selecting communication terminals belonging to the same communication region as it does from other communications terminals;
(h) the first communication terminal determining whether or not a communication terminal currently serving as a local server exists among the selected communication terminals;
(i) the first communication terminal figuring out how far it is from the local server point based upon its own location information and the location information of other communication terminal if there is no communication terminal currently serving as a local server; and
(j) the first communication terminal setting itself as a local server if it turns out to be located closest to the local server point,
if it turns out in step (e) that there exists a communication terminal currently serving as a central server or if it turns out in step (e that there exists a communications terminal located closer than the first communication terminal to the central server point.

9. A method of replacing a relay server with another relay server over a wireless communication network, comprising:
(a) a communication terminal currently serving as a central or local server receiving location information from other communication terminals;
(b) the communication terminal checking if there exists among other communication terminals a first communication terminal located closer than it is to a central or local server point by analyzing the location information of other communication terminals;
(c) the communication terminal transmitting a server setting command to set the first communication terminal as a new central or local server and server management information that it has managed to the first communication terminal and canceling information used for setting the communication terminal as a central or local server; and
(d) the first communication terminal modifying its role information in response to the server setting command so that it can be set as a central or local server and storing the received server management information.

10. A communication method, comprising:
(a) receiving location information of other communication terminals and storing the location information in a database;
(b) searching the database for location information of a receiving terminal, which is a destination of data;
(c) checking if a predetermined reference period of time has passed since, among the search results, most recent location information was recorded; and
(d) transmitting the data to the receiving terminal based upon the most recent location information,
if the predetermined reference period of time has not yet passed since the most recent location information was recorded.

11. The method of claim 10 further comprising:
(e) transmitting the data to a central server;
(f) searching a terminal information table of the central server for the location information of the receiving terminal; and
(g) the central server transmitting the data to a local server serving the searched location of the receiving terminal, if no search result has been obtained in step (b).

12. The method of claim 10 further comprising:
(h) searching the database for location information of the receiving terminal, which had been recorded directly before the most recent location information was recorded;
(i) estimating location of the receiving terminal using the most recent location information and the previous location information; and
(j) transmitting the data to a local server serving the estimated location of the receiving terminal,
if the predetermined reference period of time has already passed since the most recent location information was recorded.

13. The method of claim 12 further comprising:
(k) transmitting the data to the central server;
(l) searching the terminal information table of the central server for location information of the receiving terminal; and
(m) transmitting the data from the central server to a local server serving the searched location of the receiving terminal,
if no search result has been obtained in step (h).

14. A computer-readable recording medium, on which a program enabling the method of claim 7 is recorded.

15. A wireless communication system comprising:
a manager terminal receiving a password from a user, authorizing the received password, and setting a central or local server point; and
a plurality of communication terminals receiving the central or local server point from the manager terminal and storing the received central or local server point,
wherein among the plurality of communication terminals, a communication terminal located closest to the central or local server point is set as a central or local server terminal performing a communication relay function.

16. A wireless communication terminal, comprising:
a transmission and receiving unit receiving point information including location information of neighboring communication terminals, and information on a central or local server point, and transmitting location information of the corresponding wireless communication terminal and data received from a user;
a neighboring terminal information management unit storing the received location information of the neighboring communication terminals;
a basic setting information management unit managing information on a communication terminal set as a central or local server terminal using role information of the wireless communication terminal, and the central or local server point information;
a relay server setting unit setting the central or local server terminal based upon the central or local server point information;
a data transmission control unit estimating location of a receiving terminal, which is a destination of data, and setting up a transmission path for transmitting the data received from the user to the receiving terminal; and
an input and output unit outputting data received from the neighboring communication terminals and receiving data to be transmitted from the user.

17. A computer-readable recording medium having a data structure comprising:
a native code field where a unique code allotted to a communication terminal is recorded;
a role information field where information on a role of the communication terminal over a communication network is recorded;
a point information field where information on a central or local server point used to set location of a central or local server over the communication network is recorded; and
a data field where central or local server terminal information including a native code and location information of a communication terminal located closest to the central or local server point is recorded.
